(19) United States
(12) Patent Application Publication
(10) Pub. No.: US 2021/0256617 A1
(43) Pub. Date: Aug. 19, 2021

(54) AUTOMATED ASSESSMENT AND ISSUANCE OF SURPLUS LINE INSURANCE POLICIES

(71) Applicant: Hippo Analytics Inc. dba Hippo Insurance Services, Palo Alto, CA (US)

(72) Inventors: Arie Yelovitch, Santa Clara, CA (US); Aviad Pinkovezky, Mountain View, CA (US); Adrian Mihai Olariu, Sunnyvale, CA (US)

(21) Appl. No.: 16/795,159

(22) Filed: Feb. 19, 2020

(51) Int. Cl. G06Q 40/08; G06Q 10/10; G06F 16/25

(52) U.S. Cl. CPC G06Q 40/08; G06Q 50/16; G06F 16/252; G06Q 10/10

(57) ABSTRACT

A policy issuance architecture automatically determines whether to issue a standard insurance policy for a property to be insured, or whether the property qualifies for a surplus line insurance policy. The policy issuance architecture may include a number of databases that store various rules and regulations for states where a surplus line insurance provider may be located. The policy issuance architecture may reference these databases in determining whether to issue the surplus line insurance policy. The policy issuance architecture may also communicate with various third-party services, such as a hazard assessment service, that assess potential hazards that may be associated with the property toe be insured. The policy issuance architecture may generate one or more electronic documents for a standard insurance policy or a surplus line insurance policy depending on whether the property qualified for the standard insurance policy or the surplus line insurance policy.

### TECHNICAL FIELD

The subject matter disclosed herein generally relates to an improved decision-making system that rapidly determines whether to issue an insurance policy to a potential customer having a property that is susceptible to natural disasters and, in particular, to implementing a back-end architecture that complies with various state rules and regulations in offering a surplus line insurance policy to a potential customer.

### BACKGROUND

A person seeking to purchase an insurance policy often has to provide details about a property that he or she desires to cover with the insurance policy. The location of the property may be in area that is susceptible to one or more natural disasters, such as wildfires, hurricanes, tornadoes, earthquakes, and other such natural disasters. An insurance provider may be reluctant to issue an insurance policy where the property is located in such an area. The insurance provider may determine that the property is too risky to protect with a standard insurance policy. As such, the customer may be unable to obtain an insurance policy through a standard or, in-state, insurance provider.

To obtain insurance on a property located in a geographic location prone to natural disasters, the potential customer may attempt to purchase surplus line insurance. As known to one of ordinary skill in the art, there is a difference between an admitted insurance carrier and a surplus line insurance carrier. An admitted carrier is typically licensed by the state in which it writes and must conform to rates and form regulations. In contrast, a surplus line insurance carrier may not be licensed by the state, but allowed to do business in the state through a wholesale broker or managing general agent.

One of the many challenges in insuring a high-risk property is that obtaining surplus line insurance can be time-consuming and a confusing task. Each state may have different rules regarding when a potential customer may obtain surplus line insurance or when the surplus line insurer may offer a surplus line insurance policy to the customer. As there are some transactions that require a property to be covered by an insurance policy, delays in obtaining a surplus line insurance policy can affect these transactions. Furthermore, because the determination of whether a property should be covered by a surplus line insurance policy often requires human intervention, there can be errors and/or omissions in the paperwork leading to the issuance of the surplus line insurance policy.

### BRIEF DESCRIPTION OF THE DRAWINGS

Some embodiments are illustrated by way of example and not limitation in the figures of the accompanying drawings.

FIG. 1 is a block diagram illustrating a networked system, according to some example embodiments, including a policy issuance architecture.

FIG. 2 illustrates various components of the policy issuance architecture of FIG. 1, according to an example embodiment.

FIG. 3 illustrates a processing diagram, in accordance with an example embodiment, of the various components illustrated in FIG. 2 that implement that the disclosed policy issuance architecture.

FIGS. 4A-4D illustrate a method, in accordance with an example embodiment, for obtaining a surplus line insurance policy from the policy issuance architecture shown in FIG. 1.

FIG. 5 is a block diagram illustrating components of a machine, according to some example embodiments, able to read instructions from a machine-readable medium (e.g., a machine-readable storage medium or machine-readable storage device) and perform any one or more of the methodologies discussed herein.

### DETAILED DESCRIPTION

The description that follows describes systems, methods, techniques, instruction sequences, and computing machine program products that illustrate example embodiments of the present subject matter. In the following description, for purposes of explanation, numerous specific details are set forth in order to provide an understanding of various embodiments of the present subject matter. It will be evident, however, to those skilled in the art, that embodiments of the present subject matter may be practiced without some or other of these specific details. Examples merely typify possible variations. Unless explicitly stated otherwise, structures (e.g., structural components, such as modules) are optional and may be combined or subdivided, and operations (e.g., in a procedure, algorithm, or other function) may vary in sequence or be combined or subdivided.

This disclosure provides for an insurance policy issuance architecture that integrates and communicates with various internal and backend architectures in issuing surplus line insurance policies to one or more potential customers. The potential customer may provide bibliographical information about himself or herself, as well as information about the property to be insured. Information about the property to be insured may include a postal address of the property. The policy issuance architecture may communicate the user-provided postal address to a standardization service that determines a standardized address of the property to be insured. The standardization service may then communicate the standardized address to the policy issuance architecture.

Using the standardized address of the property to be insured, the policy issuance architecture may then obtain one or more natural disaster values or scores that indicates risks that the property will be subjected to a particular natural disaster. In one embodiment, the property is associated with a plurality of natural disaster values or scores, where each natural disaster value or score indicates a likelihood or probability that the property will be subjected to a particular natural disaster. In another embodiment, the property is associated with a single natural disaster value or score that indicates an overall likelihood that the property will be subjected to any number of natural disasters or natural disasters associated with the geographic location of the property. Additionally, and/or alternatively, the policy issuance architecture may communicate with a hazard assessment service, where the hazard assessment service provides a hazard assessment score or value that indicates that the property will be subjected to one or more hazards, including artificial (e.g., man-made) hazards or natural disasters. Man-made hazards generally include those accidents or events where the underlying cause is a human or person. A natural disaster generally includes those accidents or events where the underlying cause is something other than a human or person (e.g., a weather event, an animal, etc.).

Using the natural disaster score and/or the hazard assessment score, the policy issuance architecture then attempts to secure an insurance policy for the property to be insured. In one embodiment, the policy issuance architecture is configured with the rules and regulations by which an insurance provider is willing to provide an insurance policy. The policy issuance architecture is also configured with the governmental rules and regulations for the geographic region where the property is located in determining whether a surplus line carrier would be more suitable for issuing the insurance policy rather than a standard carrier. In this regard, the policy issuance architecture may attempt to secure an insurance policy from various standard insurance providers based on the rules and regulations where the property is located and the natural disaster and/or hazard assessment score associated with the property.

One of the challenges in issuing a surplus line insurance policy is that each state has different sets of regulations regarding when a surplus line insurance policy may be issued. Accordingly, the policy issuance architecture is configured to support a wide variety of different state regulations and to ensure that, when a surplus line insurance policy is ready for issuance, that such issuance complies with corresponding state regulations.

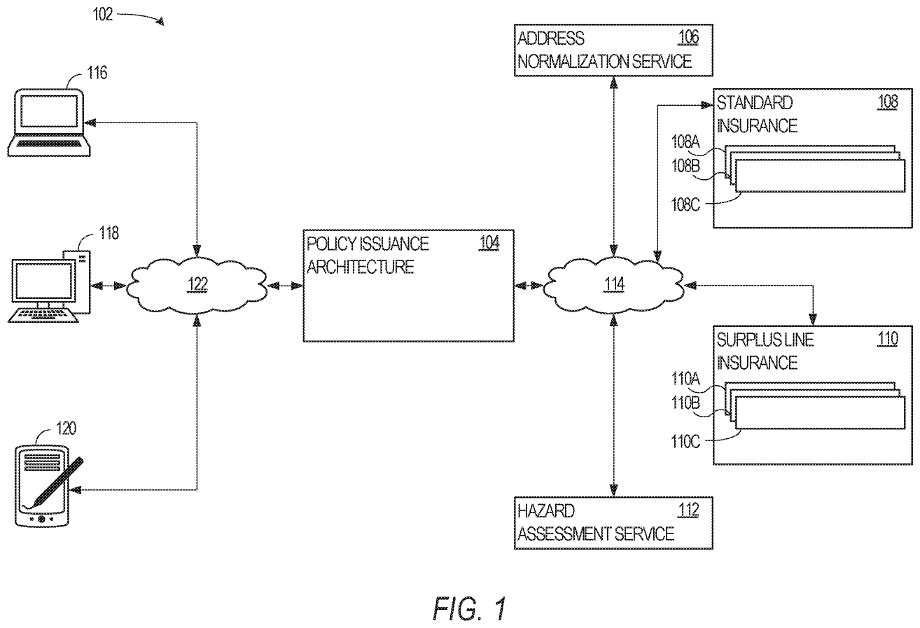

This disclosure now turns to the various disclosed embodiments that implement the technical aspects disclosed herein. With reference to FIG. 1, an example embodiment of a high-level client-server-based network architecture 102 is shown. A policy issuance architecture provides server-side functionality via a network 122 (e.g., the Internet or wide area network (WAN)) to one or more client devices 116-120. A client device, such as client device 116, may include different applications and/or modules for interacting with the policy issuance architecture 104. Examples of application that may be instantiated by the client device 116 include a web client, a single-purpose application (e.g., an “app”), a multi-purpose application (e.g., a programmatic client), or combinations thereof. The policy issuance architecture 104 is further communicatively coupled with other client devices 118-120, which may include similar applications and/or programs as the client device 116.

The client device 116 may comprise, but is not limited to, a mobile phone, desktop computer, laptop, portable digital assistant (PDA), smart phone, tablet, ultra book, netbook, laptop, multi-processor system, microprocessor-based or programmable consumer electronic, or any other communication device that a user may utilize to access the policy issuance architecture 104. In some embodiments, the client device 116 may comprise a display module (not shown) to display information (e.g., in the form of user interfaces). In further embodiments, the client device 116 may comprise one or more of touch screens, accelerometers, gyroscopes, cameras, microphones, global positioning system (GPS) devices, and so forth. The client device 116 may be a device of a user that is used to perform various interactions with the policy issuance architecture 104, such as for requesting an insurance policy quote, updating payment information, reviewing insurance policy documents, and other such interactions.

In one embodiment, the policy issuance architecture 104 is a network-based appliance that communicates notifications to the client devices 118-120, where one or more of the notifications indicate the interactions and/or activities performed by other members of the online service. One or more users may be a person, a machine, or other means of interacting with the client device 116. In various embodiments, the user is not part of the network architecture 102, but may interact with the network architecture 102 via the client device 116 or another means. For example, one or more portions of the networks 122-124 may be an ad hoc network, an intranet, an extranet, a virtual private network (VPN), a local area network (LAN), a wireless LAN (WLAN), a WAN, a wireless WAN (WWAN), a metropolitan area network (MAN), a portion of the Internet, a portion of the Public Switched Telephone Network (PSTN), a cellular telephone network, a wireless network, a WiFi network, a WiMax network, another type of network, or a combination of two or more such networks.

The client device 116 may include one or more applications (also referred to as “apps”) such as, but not limited to, a web browser, messaging application, electronic mail (email) application, a dedicated insurance policy platform application, and the like. In some embodiments, if the insurance policy application is included in the client device 116, then this application is configured to locally provide the user interface and at least some of the functionalities with the application configured to communicate with the policy issuance architecture 104, on an as needed basis, for data and/or processing capabilities not locally available (e.g., access to a policy holder profile and/or policy information, to authenticate a user, to retrieve and/or display insurance policy documents, etc.). Conversely if the social networking access client is not included in the client device 116, the client device 116 may use its web browser to access the services provided by the policy issuance architecture 104.

The user may interact with the network architecture 102 via the client device 116 or other means. For instance, the user provides input (e.g., touch screen input or alphanumeric input) to the client device 116 and the input is communicated to the client-server-based network architecture 102 via the network 122. In this instance, the policy issuance architecture 104, in response to receiving the input from the user, communicates information to the client device 116 via the network 122 to be presented to the user. In this way, the user can interact with the policy issuance architecture 104 using the client device 116.

Further, while the client-server-based network architecture 102 shown in FIG. 1 employs a client-server architecture, the present subject matter is of course not limited to such an architecture, and could equally well find application in a distributed, or peer-to-peer, architecture system, for example.

In addition to the client devices 116-120, the policy issuance architecture 104 communicates with various different types of servers and/or services 106-112. In one embodiment, the additional servers and/or services 106-112 includes an address normalization service 106, one or more insurance underwriter servers 108-110, and a hazard assessment service 112. The policy issuance architecture 104 may be configured to communicate with the one or more services and/or servers 106-112 via a network 114. Like network 122, the network 114 may be a combination of intranets. Wide Area Networks, ad-hoc networks, the Internet, and other such networks.

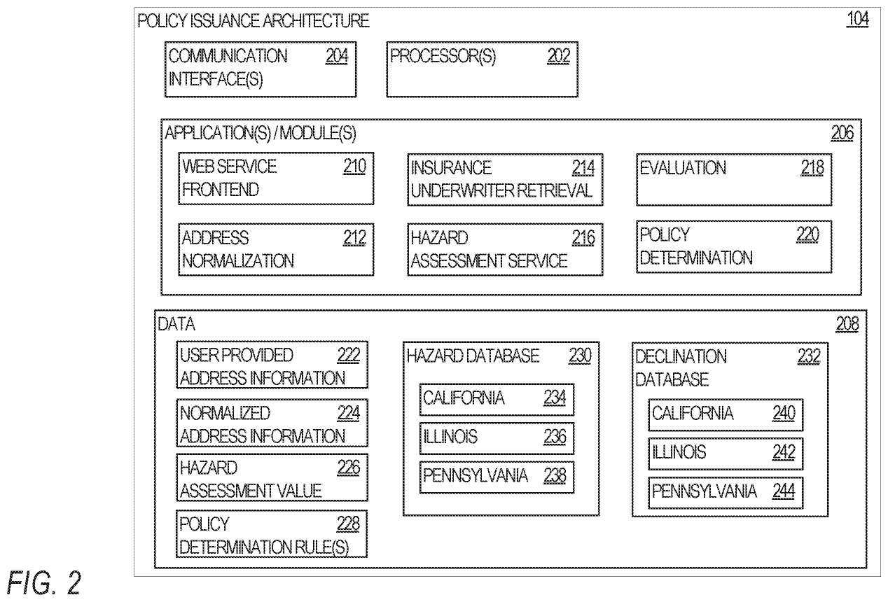

Each of the services and/or servers 106-112 may provide an application programming interface (“API”) or other means for accessing the information and/or services provided by the corresponding service and/or insurance underwriter. With regard to the address normalization service 106, this service may provide the policy issuance architecture 104 with a normalized address when given a partial and/or complete address. The policy issuance architecture 104 may then use the normalized address to determine whether the property is subject to one or more hazards and, if so, whether one or more insurance underwriters are able to underwrite an insurance policy for the property. As discussed below with reference to FIG. 2, the various insurance underwriters may have different rules and/or regulations by which they can underwrite a given property based on the hazards associated with that property

The insurance underwriter servers 108-110 may correspond to insurance underwriters that support the insurance agency that operates the policy issuance architecture 104. In one embodiment, the insurance underwriter servers 108-110 include servers 108A-108C corresponding to standard insurance underwriters 108 and servers 110A-110C corresponding to surplus line insurance underwriters. In general, a standard insurance underwriter is an insurance underwriter that is licensed by the state in which the property is located. The standard insurance underwriter may have to comply with the rules and regulations for the state (or other political entity) in which the property is located in order to underwrite an insurance policy for that policy. In contrast, a surplus line insurance underwriter may be considered an insurance underwriter that is licensed in a state other than the state (or political entity) in which the property is located. The surplus line insurance underwriter may be required to comply with a different set of rules and/or regulations than the standard insurance underwriter. As discussed below with reference to FIG. 2, a homeowner or potential policy owner may have to contract with a surplus line insurance underwriter in the event that the property to be insured is deemed too risky by a standard insurance underwriter.

In one embodiment, each insurance underwriter contracted with the insurance agency leverages or employs an insurance underwriter server 108A-108C or insurance underwriter server 110A-110C that provides various types of insurance-related information to the policy issuance architecture 104, including information relating to or about the acceptable risks that the insurance underwriter is willing to take in insuring a particular property. For example, an insurance underwriter may establish a series of rules that control whether a particular property can be insured based on one or more hazards (or one or more hazard values) that are associated with the property.

The servers 108-110 may operate on a push-based and/or subscription-based model. In a push-based model, the servers 108-110 send an electronic communication to the policy issuance architecture 104 notifying the policy issuance architecture 104 that an update to one or more hazard restriction rules is available along with the information associated with the update. In this instance, an update may mean a new hazard restriction rule, a change in an existing hazard restriction rule, or the termination/deletion of a hazard restriction rule. Examples of push-based models include, but are not limited to, streaming via the HyperText Markup Protocol (HTTP), persistent HTTP connections, the use of the Simple Mail Transfer Protocol (“SMTP”) in conjunction with Post Office Protocol Version 3 (“POP3”) or Internet Message Access Protocol (“IMAP”), the services available under the Extensible Messaging and Presence Protocol (“XMPP”), one or more WebHooks, and other such push-based models or combinations thereof.

Additionally, and/or alternatively, the servers 108-110 may operate on a pull-based model for delivering updates on one or more hazard restriction rules. In general, a pull-based model is a system where a client (e.g., the policy issuance architecture 104) queries a provider (e.g., the servers 108-114) whether certain types of information are available or whether there are updates to information that the client expects to be available. Under this regime, the policy issuance architecture 104 may implement a pull-based model to determine whether there are any updates to one or more hazard restriction rules maintained by the insurance underwriters. In implementing the pull-based model, the policy issuance architecture 104 may request updates from the various servers 108-110 at predetermined time intervals (e.g., every 15 minutes) and/or on a predetermined schedule (e.g., once a day). In some instances, the policy issuance architecture 104 may implement both a push-based model and a pull-based model for one or more of the servers 108-114 that are in communication with the policy issuance architecture 104.

The hazard assessment service 112 is configured to provide a hazard assessment value to the policy issuance architecture 104 in response to information provided about a property to be insured. In the context of the hazard assessment service 112, a hazard may be a man-made hazard (e.g., potential for civil unrest, a crime rate (violent and/or non-violent), a potential for a facility accident (e.g., an explosion at a power-generating facility), etc.) or a natural hazard (e.g., a wild fire, natural flooding, an earthquake, etc.) One example of a hazard assessment service 112 that may be in communication with the policy issuance architecture 104 is Zesty.ai, which provides a risk analytics platform that can assess hazards associated with a particular property, or GIA Map, which provides risk scoring and threat assessment for a particular property. As discussed above, the hazard assessment service 112 may provide an API that allows the policy issuance architecture 104 to invoke the services offered by the hazard assessment service 112 and obtain the hazard assessment value.

In one embodiment, the policy issuance architecture 104 communicates one or more addresses to the hazard assessment service 112, which then responds with one or more hazard assessment attributes and/or hazard assessment values associated with each of the addresses. Depending on the granularity of hazard assessment requested by the policy issuance architecture 104, the hazard assessment attributes may include individual hazard assessment values for one or more potential hazard (e.g., a natural fire hazard value, an earthquake hazard value, etc.). Additionally, and/or alternatively, the hazard assessment values may include one or more values associated with a particular type of hazard, such as a natural disaster hazard assessment value, a man-made disaster hazard assessment value, and/or a global hazard assessment value that includes both natural disasters and man-made disasters. As discussed below with reference to FIG. 2, the policy issuance architecture 104 may store the hazard assessment values and use them in determining whether the property should be assigned to a standard insurance underwriter or a surplus line insurance underwriter for underwriting an insurance policy for the property.

FIG. 2 illustrates various components of the policy issuance architecture 104 of FIG. 1, according to an example embodiment. In one embodiment, the policy issuance architecture 104 includes various application(s) and/or modules(s) 206 to facilitate the real-time determination of whether a standard insurance underwriter or a surplus line insurance underwriter should underwrite an insurance policy for a particular property, and data 208 used to support one or more functionalities of the application(s) and/or module(s) 206. Although not shown in detail, the policy issuance architecture 104 may also include hardware and/or software components typically implemented in one or more computing devices, such as one or more hardware processors, one or more computer-readable media, one or more communication interfaces, one or more input and/or output devices, and other such components found in a computing device.

The various functional components of the policy issuance architecture 104 may reside on a single device or may be distributed across several computers in various arrangements. The various components of the policy issuance architecture 104 may, furthermore, access one or more databases (e.g., the hazard database 230 and/or the declination database 232), and each of the various components of the policy issuance architecture 104 may be in communication with one another. Further, while the components of FIG. 2 are discussed in the singular sense, it will be appreciated that in other embodiments multiple instances of the components may be employed.

The policy issuance architecture 104 may include one or more processor(s) 202 configured to execute one or more computer-executable instructions for instantiating the various application(s)/module(s) 206. The processor(s) 202 of the policy issuance architecture 104 may be any type of commercially available processor, such as processors available from the Intel Corporation, Advanced Micro Devices, Texas Instruments, or other such processors. Further still, the one or more processors may include one or more special-purpose processors, such as a Field-Programmable Gate Array (FPGA) or an Application Specific Integrated Circuit (ASIC). The processor(s) 202 may also include programmable logic or circuitry that is temporarily configured by software to perform certain operations. Thus, once configured by such software, the processor(s) 202 become specific machines (or specific components of a machine) uniquely tailored to perform the configured functions and are no longer general-purpose processors.

The policy issuance architecture 104 also include one or more communication interface(s) 204 for establishing one or more communication channels with various devices, servers, and equipment. In one embodiment, the policy issuance architecture 104 uses the communication interface(s) 104 to establish communication channels with the client devices 116-120, the address normalization service 106, and the various servers 108-112, such as the standard insurance servers 108, the surplus line insurance servers 110, and the hazard assessment service 112. The communication interface(s) 104 may include one or more wired and/or wireless communication interfaces such as IEEE 802.3. IEEE 802.11, Bluetooth, or any other wired and/or wireless communication interface now known or later developed. The policy issuance architecture 104 may also use the communication interface(s) 204 to facilitate human/machine interactions using one or more input and/or output devices such as a keyboard, mouse, microphone, speakers, displays (touchscreen or otherwise), and other such input and/or output devices. Examples of communication interface(s) 204 used by the policy issuance architecture 104 for input and/or output devices, include, but are not limited to, PS/2, Universal Serial Bus (“USB”). High-Definition Multimedia Interface (“HDMI”), Thunderbolt, or any other communication interface used for human/machine interactions now known or later developed.

Using various machine-readable media, the policy issuance architecture 104 implements the application(s) and/or module(s) 206 and stores the data 208. The machine-readable media may include one or more devices configured to store instructions and data temporarily or permanently and may include, but not be limited to, random-access memory (RAM), read-only memory (ROM), buffer memory, flash memory, optical media, magnetic media, cache memory, other types of storage (e.g., Erasable Programmable Read-Only Memory (EEPROM)) and/or any suitable combination thereof. The term “machine-readable media” should be taken to include a single medium or multiple media (e.g., a centralized or distributed database, or associated caches and servers) able to store the application(s) and/or module(s) 206 and the data 208. The term “machine-readable media” may also include one or more machine-readable storage devices. Accordingly, the machine-readable medium may be implemented as a single storage apparatus or device, or, alternatively and/or additionally, as “cloud-based” storage systems or storage networks that include multiple storage apparatus or devices.

In one embodiment, the application(s) and/or module(s) 206 are written in a computer-programming and/or scripting language. Examples of such languages include, but are not limited to, C. C++, C#, Java, JavaScript, Perl, Python, or any other computer programming and/or scripting language now known or later developed. In this manner, each of the application(s) and/or module(s) 206 may be implemented in one or more computer-programming and/or scripting language.

With reference to FIG. 2, the application(s) and/or module(s) 206 of the policy issuance architecture 104 are configured to obtain hazard restriction rules from one or more of the standard insurance underwriters 108 and/or surplus line insurance underwriters 110, determine whether a standard insurance policy can be issued for a particular property, determine whether a surplus line insurance policy can be issued for the particular property, and/or issue the standard insurance policy or the surplus line insurance policy for the particular property.

To perform the foregoing operations and other operations in support thereof, the application(s) and/or module(s) 206 include, but are not limited to, a web service frontend 210, an address normalization module 212, and insurance underwriter retrieval module 214, and a hazard assessment service module 216. The application(s) and/or module(s) 206 may also include an evaluation module 218 and a policy type determination module 220. Each of the application(s) and/or module(s) 206 are discussed further below. While the policy issuance architecture 104 may include alternative and/or additional applications (e.g., a web-hosting platform, a networking application, a printing application, a software-implemented keyboard, etc.), such alternative and/or additional applications are not germane to this disclosure and the discussion of such is hereby omitted for brevity and readability.

The data 208 referenced and used by the application(s) and/or module(s) 206 include various types of data in support of determining whether a property to be insured should be associated with a standard insurance policy or a surplus line insurance policy. In this regard, the data 208 user provided address information 222, standardized address information 224, one or more hazard assessment values 226, and various policy determination rules 228. The data 208 also includes a hazard database 230, which includes state-specific databases 234-238 that include associations between properties to be insured and their respective hazard assessment values 226, and a declination database 232, which includes state-specific databases 240-244 that records declinations for each property in which a standard insurance underwriter was unable to underwrite an insurance policy for a corresponding property.

The web service frontend 210 is configured to facilitate interactions between the policy issuance architecture 104 and potential customers seeking to obtain an insurance policy on one or more properties. In one embodiment, the web service frontend 210 provides a graphical user interface in the form of one or more webpages that a potential customer uses to interact with the policy issuance architecture 104. Using the web service frontend 210, a potential customer may provide information about himself or herself (e.g., bibliographic information) and information about the property to be insured. The bibliographic information about the potential customer may include his or her name, his or her occupation, his or her level of income, and other such bibliographic information. In one embodiment, the web service frontend 210 notifies the potential customer that bibliographic information is requested and receives confirmation (e.g., an e-signature or the like) that the potential customer acknowledges that the bibliographic information is being provided to the policy issuance architecture 104.

In addition to the bibliographic information, the potential customer may provide one or more addresses for one or more properties to be insured. In one embodiment, the potential customer types the addresses into one or more webpage elements, such as text field, form field, text box, or the like. The potential customer may then select another webpage element, such as a submission button, that submits the entered address information to the policy issuance architecture 104.

One of the challenges in offering insurance policies to customers through an online service is that the address of the property to be insured may be incorrect or may be in an incorrect format. For example, the potential customer may use a town name different from the town in which the property is located, or use an incorrect ZIP code to identify the property. Accordingly, the policy issuance architecture 104 implements an address normalization module 212 to communicate with the address normalization service 106. In one embodiment, the policy issuance architecture 104 communicates the received address information from the potential customer to the address normalization service 106. The address normalization service 106 then attempts to map the user-provided address with a normalized address. In this context, a normalized address may be an address that is formally recognized by a governmental entity, such as the United States Postal Service (“USPS”). The address normalization service 106 may then communicate a message to the policy issuance architecture 104, where the message either indicates that the address normalization service 106 could not find a normalized address for the user-provided address or the normalized address for the user-provided address. Examples of address normalization services include SmartyStreets and Experian, where each service provides an API for allowing third-parties to access their address normalization services. Thus, the policy issuance architecture 104 may implement the address normalization module 212 to access the services provided by the address normalization service 106.

Where the address normalization service 106 is unable to normalize the user-provided address, the policy issuance architecture 104 may display a message, via the web service frontend 210, that the user-provided address could not be normalized. In this case, the policy issuance architecture 104 may invite the potential customer to provide or retry the address. Alternatively, where the address normalization service 106 returns a normalized address, the policy issuance architecture 104 may store the normalized address as the normalized address information 224. Where multiple addresses are provided by the potential customer (e.g., the potential customer desires to purchase an insurance policy for one or more properties), each property may be associated with a normalized address 224.

One of the challenges in issuing an insurance policy is that the property to be insured may be inherently risky—in other words—near various hazards. Having a property that is subject to one or more hazards may be considered challenging to insure properly. To ensure that an insurance underwriter is informed of the risks associated with a particular property, the policy issuance architecture 104 communicates with the hazard assessment service 112 to determine one or more hazard assessment value(s) 226 for a given property. As discussed above, a hazard assessment value may indicate a likelihood or probability that a particular property will experience a particular hazard. To obtain the one or more hazard assessment value(s) 226, the policy issuance architecture 104 may be configured with a hazard assessment service module 216 that implements one or more APIs for the hazard assessment service 112. In one embodiment, the policy issuance architecture 104 communicates the normalized address information 224 for the property to be insured to the hazard assessment service 112 via the hazard assessment service module 216. In reply, the policy issuance architecture 104 may receive one or more hazard assessment value(s) 226 for the property to be insured.

As the policy issuance architecture 104 receives the hazard assessment value(s) 226, the policy issuance architecture 104 may store the received hazard assessment value(s) 226 in a hazard database 230, where the hazard database 230 includes one or more logical constructs 234-238 corresponding to states where a property may be located. In one embodiment, the hazard database 230 is implemented as one or more JavaScript Object Notation (JSON) files, and the logical constructs 234-238 are each implemented as separate JSON files. Additionally, and/or alternatively, the policy issuance architecture 104 may implement the hazard database 230 using another structured language, such as Extensible Markup Language (“XML”) or Standard Generalized Markup Language (“SGML”). In an alternative embodiment, each of the logical constructs 234-238 are implemented as database tables, so that each state in which an insurance policy may be issued is associated with a corresponding database table. Accordingly, one of ordinary skill in the art will appreciate that the logical constructs 234-238 are structured to

The logical constructs 234-238 store the hazard assessment value(s) 226 for a particular property depending on the normalized address information 224 associated with the property. For example, the California logical construct 234 may store hazard assessment values for those properties located in the state of California. Similarly, the Illinois logical construct 236 may store the hazard assessment values for those properties located in the state of Illinois. By ensuring that the policy issuance architecture 104 is configured with a hazard database 230 having logical constructs for each state in which the policy issuance architecture 104 issues an insurance policy, the policy issuance architecture 104 can accurately maintain and monitor the hazard assessment values for those properties. As discussed further below, each state may implement its own rules and regulations regarding the conditions under which a surplus line insurance policy may be issued, and organizing the hazard assessment values by state (e.g., by the one or more logical constructs 234-238) ensures that the policy issuance architecture 104 can readily determine whether a particular property should be associated with a standard insurance policy or a surplus line insurance policy.

The insurance underwriter retrieval module 214 is configured to obtain one or more policy determination rules 228 from the standard insurance underwriters 108 and/or the surplus line insurance underwriters 110. One of the challenges in implementing a policy issuance architecture 104 that provides insurance policies for properties located in different states, is that each state may have its own rules or regulations regarding whether a particular property may be insured under a standard insurance policy or a surplus line insurance policy. Accordingly, the insurance underwriter retrieval module 214 is configured to interact with insurance underwriters and retrieve one or more insurance policy determination rules that determine whether a particular property may be insured via a standard insurance policy or a surplus line insurance policy. In one embodiment, the insurance underwriter retrieval module 214 calls one or more functions or methods of an API provided by the insurance underwriter servers 108-110. For example, the API may provide retrieval or update methods that allow the insurance underwriter retrieval module 214 to retrieve policy determination rules and/or update previously retrieved policy determination rules. The insurance underwriter retrieval module 214 may store the policy determination rules as policy determination rule(s) 228. Although not shown in FIG. 2, the policy determination rule(s) 228 may be stored in a policy database and logically organized using one or more logical constructs (e.g., the policy determination rule(s) 228 may be organized according to city, state, insurance underwriter, type of insurance underwriter, and so forth).

The policy issuance architecture 104 may also include a policy type determination module 220 that executes and/or evaluates the policy determination rule(s) 228 using the normalized address information 224 and/or the hazard assessment values stored in the hazard database 230. Using the policy determination rule(s) 228, the policy type determination module 220 determines whether a property is suitable for a standard insurance policy or a surplus line insurance policy. In general, the policy determination rule(s) 228 executed by the policy type determination module 220 correspond to the insurance underwriter that is offering an insurance policy in the state (or other geographic region) in which the property, identified by the normalized address information 224, is located. In executing the policy determination rule(s) 228, the policy type determination module 220 may first determine which insurance underwriters are available to underwrite an insurance policy. The policy type determination module 220 may then retrieve or execute the policy determination rule(s) 228 associated with the determined insurance underwriters using the normalized address information 224 of the property to be insured and the hazard assessment value(s) for the property.

Where the policy determination rule(s) 228 determine that a particular property is too risky (e.g., one or more policy determination rule(s) 228 determine that the one or more hazard assessment value(s) 226 meet or exceed a policy determination threshold value), the policy determination rule(s) 228 determine that the property cannot be underwritten with a standard insurance policy. This determination may be stored as a declination in the declination database 232. Similar to the hazard database 230, the declination database 232 may include a plurality of declination records that correspond to the declinations that a particular property has received. In one embodiment, the declination database 232 is implemented as one or more JSON files, and the logical constructs 234-238 are each implemented as separate JSON files.

A declination record may include one or more declination record attributes, such as the address information for the property to be insured, the insurance underwriter that issued the declination, the date on which the declination was issued, and the time at which the declination was issued. A property may be associated with multiple declination records, and the declination database 232 may include logical constructs 240-244, which may organize or store the declination records according to the state in which a property is located. As shown in FIG. 2, there may be a California logical construct 240 that organizes declination records received for properties located in California, an Illinois logical construct 242 that organizes declination records received for properties located in Illinois, and a Pennsylvania logical construct 244 that organizes declination records received for properties located in Pennsylvania. Although three states are shown for the declination database 232, the declination database 232 may include additional or alternative states as well.

A declination record may be used as evidence that a particular property should be covered by a surplus line of insurance. In some instances, a state may require that a potential customer receive a predetermined number of declinations for a particular property (e.g., three declinations) before the potential customer is quoted or issued a surplus line insurance policy for a property to be insured. To ensure that the policy insurance architecture complies with the rules and/or regulations of a particular state, the declination database 20 may also include the rules and/or regulations for a state. Similar to the declination records, the logical constructs 240-244 may also include the rules and/or regulations that specify the number of declinations a customer should receive prior to the customer being eligible for a surplus line insurance policy.

To determine whether a potential customer has received a sufficient number of declinations, the evaluation module 218 is configured to reference the declination database 232 and output whether a potential customer is eligible for a surplus line insurance policy. In one embodiment, the evaluation module 218 accepts, as input, a customer identifier and a property identifier; the evaluation module 218 then references the declination database 232 with the provided information to determine the number of declination records associated with the customer identifier and the property identifier. Of course, in some instances, the evaluation module 218 may be provided with different inputs or identifiers that identify the customer and the property to be insured.

The evaluation module 218 then compares the number of declinations that the customer has received for the particular property with the number of declinations required by a particular state, such as the state where the property is located. Where the customer has received the requisite number of declinations for the property being insured, the evaluation module 218 then generates an output to the web service fronted 210, which informs the potential customer that he or she is eligible to enroll in a surplus line insurance policy. Alternatively, where the evaluation module 218 determines that the customer and/or the property has not received the requisite number of declinations, the evaluation module 218 may generate a message to the web service frontend 210 that the customer and/or the property is not eligible for a surplus line insurance policy. In this case, the web service frontend 210 may inform the potential customer that he or she is not eligible for a surplus line insurance policy along with recommendations and/or suggestions for obtaining an insurance policy that meets his or her needs.

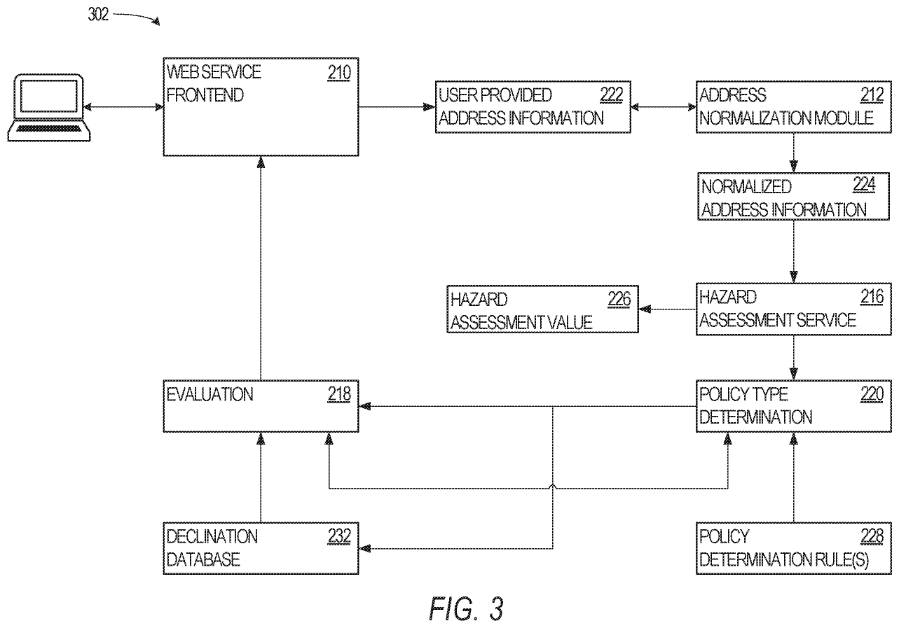

FIG. 3 illustrates a processing diagram 302, in accordance with an example embodiment, of the various components illustrated in FIG. 2 that implement the disclosed policy issuance architecture 104. As shown in FIG. 3, the web service frontend 210 is communicatively coupled with the client device and configured to invoke the address normalization module 212. In one embodiment, the web service frontend 210 provides one or more webpages to the client device that the user (e.g., a policyholder or potential customer) can interact with to provide user information including, but not limited to, a policy number, address, biographical information (e.g., first name, last name, age, date of birth, etc.), and other such information. The web service frontend 210 may then communicate with the address normalization module 212, which then executes a function and/or method provided by the address normalization service 106.

As explained above, the web service frontend 210 may communicate user provided address information 222 to the address normalization module 212, and the address normalization module 212 may request that the address normalization server 106 return a normalized (or standardized) address from the user provided address information 222. The address normalization module 212 may receive a normalized address from the normalized address service 106, and store the normalized address as normalized address information 224. The policy issuance architecture may then use the normalized address information in subsequent executions of one or more of the modules 210-220 where address information is needed.

The web service frontend 210 and/or the address normalization module 212 may then invoke the hazard assessment service module 216 using the normalized address information 224. As explained above, the hazard assessment service module 216 is configured to obtain one or more hazard assessment value(s) 226 corresponding to the normalized address information 224. In one embodiment, the hazard assessment service module 216 obtains the one or more hazard assessment value(s) from the hazard assessment service 112. In reply, the policy issuance architecture 104 may receive one or more hazard assessment value(s) 226 for the property to be insured.

The web service frontend 210 and/or the policy issuance architecture 104 may then invoke the policy type determination module 220 to determine whether the property corresponding property is suitable for a standard insurance policy or a surplus line insurance policy. The policy type determination module 220 may execute and/or evaluate one or more of the policy determination rule(s) 228 corresponding to the insurance underwriter that is offering an insurance policy in the state (or other geographic region) in which the property, identified by the normalized address information 224, is located. Where the policy type determination module 220 determines that a particular property is too risky (e.g., one or more policy determination rule(s) 228 determine that a policy determination result meets or exceeds a policy determination threshold value), the policy type determination module 220 may generate and/or store a declination record corresponding to the property in the declination database 232. The declination record may include information identifying the customer, the property associated with the declination record, one or more reasons for the declination, one or more of the hazard assessment value(s) 226 that led to the declination, and other such information or combinations thereof.

Alternatively, where the policy type determination module 220 determines that a policy may be issued for the property, the policy type determination module 220 may instruct the evaluation module 218 to display a notification to the user, via the web service frontend 210, that one or more insurance underwriters are willing to issue a standard insurance policy for the property.

Where the policy type determination module 220 generates and/or stores a declination record for the customer and/or property, the policy type determination module 220 may then invoke the evaluation module 218. The evaluation module 218 is configured to determine whether the customer and/or property has received a sufficient number of declinations to be eligible for a surplus line insurance policy. In one embodiment, the evaluation module 218 references one or more rules stored in the declination database 232 to perform this determination. The one or more rules may be associated with a particular state and/or insurance carrier that, when evaluated, provides a result that indicates whether the customer and/or property is eligible for the surplus line insurance policy. In one embodiment, a rule may specify a predetermined number of declinations that a customer and/or property should have for the customer and/or property to be eligible for the surplus line insurance policy.

Where the evaluation module 218 determines that the customer and/or property has not received a sufficient number of declinations, the evaluation module 218 may instruct the policy type determination module 220 to evaluate the property to be insured using a different set of policy determination rule(s) 228, such as a different set of policy determination rule(s) 228 associated with a different insurance underwriter. The policy type determination module 220 and the evaluation module 218 may perform this process iteratively until one or more predetermined condition(s) are met. For example, the policy type determination 220 and the evaluation module 218 may perform this iterative process until there are no standard insurance underwriters available or there are no policy determination rule(s) 228 left to evaluate for the particular property and/or customer. As another example, the policy type determination module 220 and the evaluation module 218 may perform this iterative process until the customer and/or property has met or achieved the predetermined number of declinations needed to be eligible for a surplus line insurance policy. This process provides a technical benefit to the system because it automates a process that would ordinarily involve a non-trivial amount of computing resources and communications to evaluate whether a particular customer or property is eligible for a surplus line of insurance.

The evaluation module 218 may then output a result to the customer via the web service frontend 210. Where the evaluation module 218 and/or the policy type determination module 220 perform this iterative process, the web service frontend 210 may automatically display a message or other notification when a predetermined number of declination records have been generated or determined for the customer or property. Where the iterative process is not implemented, the web service frontend 210 may display a message or other notification informing the customer of the declination and that the system will re-determine whether the property is eligible for a surplus line insurance using the standards and/or rules for another insurance underwriter. Whether the policy issuance architecture 104 implements the iterative process between the evaluation module 218 and the policy determination module 220 may be configured by an administrator or other operator of the policy issuance architecture 104.

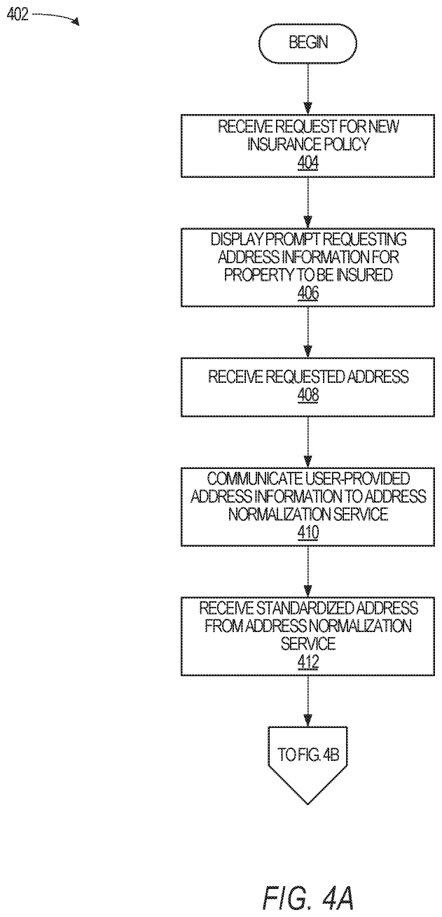

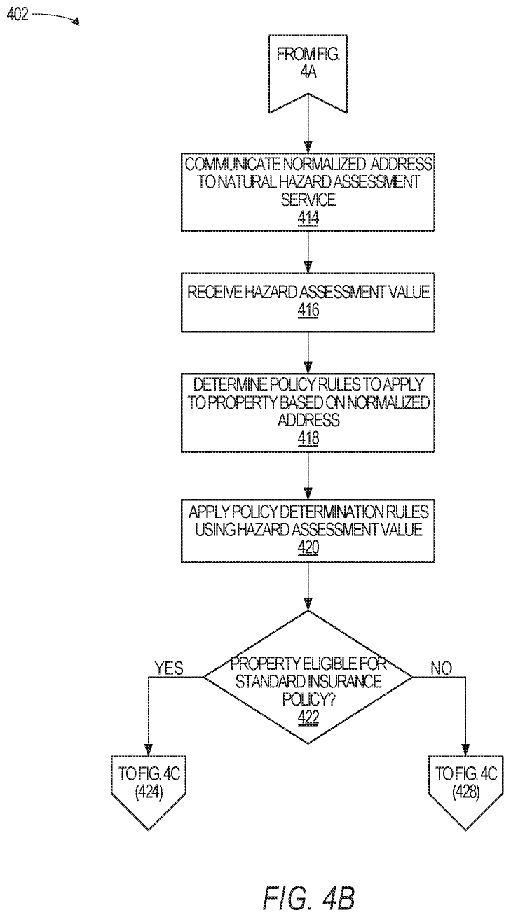

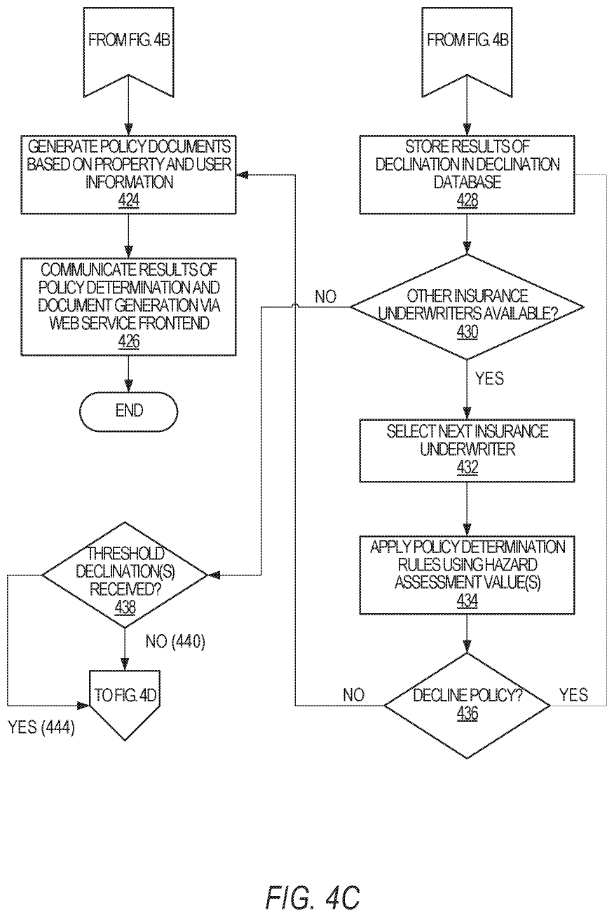

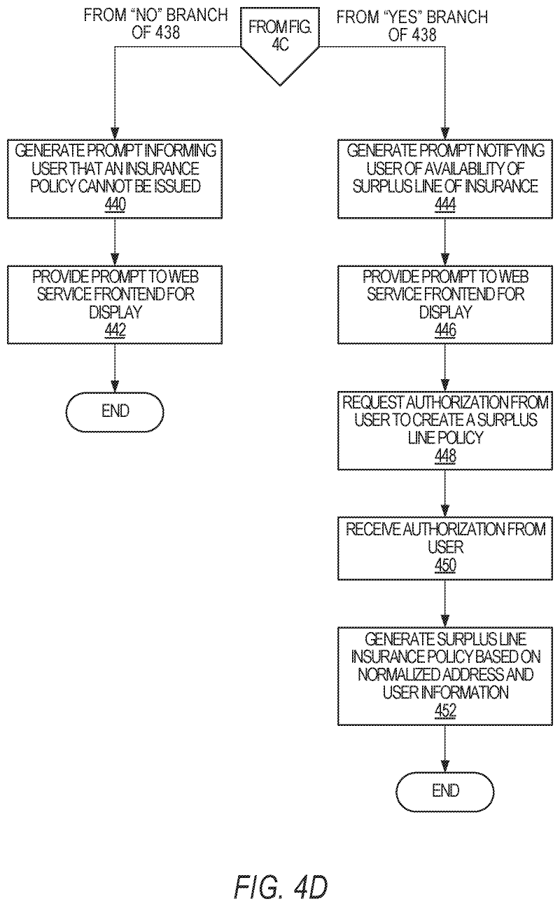

FIGS. 4A-4D illustrate a method 402, in accordance with an example embodiment, for obtaining a surplus line insurance policy from the policy issuance architecture 104 shown in FIG. 1. The method 402 may be implemented by one or more of the components illustrated in FIG. 2 and is discussed by way of reference thereto.

Referring initially to FIG. 4A, the web service frontend 210 of the policy issuance architecture 104 receives a request for a new insurance policy (Operation 404). During the course of conducting customer intake, the web service frontend 210 may display a webpage, or other prompt, requesting that the customer provide address information for the property to be insured (Operation 406). The address information may include a street address, apartment number, city, state, ZIP code, and other such address information. In response to the displayed prompt, the web service frontend 210 receives the address information and may store the address information as the user-provided address information 222.

As people sometimes write the same address differently, the policy issuance architecture 104 may communicate with an address normalization service 106 to normalize the user-provided address information 222. Accordingly, the policy issuance architecture 104 may communicate the user-provided address information 222 to the address normalization service 106 via an address normalization module 212 (Operation 408). In response, the policy issuance architecture 104 may receive a normalized address from the address normalization service 106, and may store the normalized address as the normalized address information 224 (Operation 410).

Turning next to FIG. 4B, the policy issuance architecture 104 next obtains a hazard assessment value that represents a level of risk associated with the property to be insured based on or more hazards that may affect the property. The policy issuance architecture 104 may communicate the normalized address information 224 to a hazard assessment service 112 using a hazard assessment service module 216 (Operation 414). The policy issuance architecture 104 may then receive one or more hazard assessment values 226 from the hazard assessment service 112 via the hazard assessment service module 216 (Operation 416). As explained previously, the one or more hazard assessment values 226 may include hazard assessment values corresponding to natural hazards, man-made hazards, or combinations thereof.

The policy issuance architecture 104 then determines which policy determination rule(s) 228 to apply to the property to be insured based on the normalized address information 224 (Operation 418). In one embodiment, the policy determination module 220 selects those policy determination rule(s) 228 that correspond to a state or insurance underwriter. The selection of the policy determination rule(s) 228 may be based on a geographic location where the property to be insured is located, which may be determined from the normalized address information 224. The policy determination rule(s) 228 may include multiple sets of rules depending on the number of insurance underwriters affiliated or partnered with the policy issuance architecture 104. For each insurance underwriter affiliated with the policy issuance architecture 104, there may be a corresponding set of policy determination rule(s) 228. In addition to selecting which of the policy determination rule(s) 228 to evaluate based on the geographic location of the property to be insured, the selection of the policy determination rule(s) 228 may be further based on one or more organizational constructs, such as alphabetical (e.g., policy determination rule(s) 228 associated with insurance underwriters are processed according to the name of the insurance underwriter), a priority or ranking value (e.g., policy determination rule(s) 228 associated with insurance underwriters are processed according to a ranking associated with the insurance underwriter), a first-in-last-out approach (e.g., policy determination rule(s) 228 associated with insurance underwriters are processed according to a seniority associated with the insurance underwriter), or other such organizational constructs or combinations thereof.

The policy determination type module 220 then evaluates the selected policy determination rule(s) 228 using the normalized address information 224 and the one or more hazard assessment values 226 (Operation 420). Where the policy determination rule(s) 228 determine that a particular property is eligible for a standard insurance policy (e.g., one or more policy determination rule(s) 228 determine that one or more of the hazard assessment value(s) 226 do not exceed a policy determination threshold value), the policy determination rule(s) 228 determine that the property can be underwritten with a standard insurance policy (e.g., the “YES” branch of Operation 422). Alternatively, where the policy determination rule(s) 228 determine that a particular property is ineligible for a standard insurance policy (e.g., one or more policy determination rule(s) 228 determine that one or more of the hazard assessment value(s) 226 meet or exceed a policy determination threshold value), the policy determination rule(s) 228 determine that the property cannot be underwritten with a standard insurance policy (e.g., the “NO” branch of Operation 422)

With reference to FIG. 4C, the policy issuance architecture 104 either prepares a standard insurance policy for the customer or attempts to determine whether the customer could qualify for a surplus line insurance policy. Operation 424 continues from Operation 422 of FIG. 4B, where the policy determination module 220 has determined that the customer and/or property is eligible for a standard insurance policy. At Operation 424, the policy issuance architecture 104 generates electronic version of one or more policy documents for the property to be insured and the customer (Operation 424). In one embodiment, the electronic versions of the policy documents are stored as templated with one or more fillable fields, and the policy issuance architecture 104 populates the fillable fields of the templates to create the policy documents for the customer. The policy issuance architecture 104 may populate the fillable fields with various types of information, such as the insurance underwriter information, the customer or user information, the property information, policy number and/or pricing information, and other such information that may be provided by the customer/user and/or the insurance underwriter.

At Operation 426, the web service frontend 210 communicates to the user that the user and/property to be insured are eligible for a standard insurance policy. The web service frontend 210 may also present one or more of the policy insurance documents generated by the policy issuance architecture 104. The user/customer may then accept the terms of the generated insurance policy and obtain (e.g., download) the electronically generated insurance policy documents.

Referring to Operation 428, which follows from the “NO” branch of Operation 422, the policy issuance architecture 104 stores a declination record for the initial determination of ineligibility in the declination database 232 (Operation 428). The policy issuance architecture 104 then determines whether there are additional insurance underwriters that could provide or underwriter a standard insurance policy (Operation 430). For example, the policy issuance architecture 104 may reference the policy determination rule(s) 228 and/or the hazard database 230 to determine which insurance underwriters are available to underwrite or issue a standard insurance policy.

Where the policy issuance architecture determines that there are additional insurance underwriters available (e.g., the “YES” branch of Operation 430), the method 402 proceeds to Operation 432, where the policy issuance architecture 104 selects the next insurance underwriter for processing the request for an insurance policy. The policy issuance architecture 104 then invokes the policy determination module 220 for selecting the set of policy determination rule(s) 228 that correspond to the selected insurance underwriter, and the policy determination module 220 evaluates the policy determination rule(s) 228 using the normalized address information 224 and the one or more hazard assessment value(s) 226 (Operation 434). In some instances, the policy determination module 220 may retrieve the one or more hazard assessment value(s) 226 from the hazard database 230.

The policy determination module 220 then determines whether to decline the issuance of a standard insurance policy based on the evaluation of the policy determination rule(s) 228. Where the policy determination module 220 determines to that the customer or user is not eligible for the standard insurance policy, the method 402 returns to Operation 428, where the policy determination module 220 stores the determination of ineligibility as a declination record in the declination database 232.

Next, and with reference to FIG. 4D, the policy issuance architecture 104 displays a prompt depending on whether the customer or property to be insured has received the predetermined number of declinations. At Operation 440, the policy issuance architecture 104 generates a prompt informing the user or customer that an insurance policy cannot be issued. This prompt may be displayed because the customer and/or property does not qualify for the standard insurance policy and may not have received a sufficient number of declinations to be eligible for the surplus line insurance policy. This prompt is then presented to one or more of the client devices 116-120 (Operation 442).

Alternatively, at Operation 444, the policy issuance architecture 104 generates a prompt informing the customer or user that the property to be insured may be covered by a surplus line of insurance (Operation 444). At Operation 446, the prompt is presented to one or more of the client devices 116-120. Furthermore, the policy issuance architecture 104 may request authorization from the user or customer to issue, and/or confirm issuance of, the surplus line insurance policy (Operation 448). The authorization is requested to ensure that the customer or user still desires to obtain insurance for the property identified by the normalized address information 224. Where the policy issuance architecture 104 receives authorization from the user or customer (Operation 450), the policy issuance architecture 104 may then generate a surplus line insurance policy for the user or customer based on user information, the normalized address information 224, and the one or more hazard assessment value(s) 226 (Operation 452). As explained above with reference to Operation 424, the policy issuance architecture 104 may generate electronic documents for the surplus line insurance policy by populating fillable fields of one or more template documents. The policy issuance architecture 104 may then present the generated electronic documents to the customer or user, where the customer or user may download the generated electronic documents for offline reading.

In this manner, the disclosed policy issuance architecture 104 provides a rapid response system for a user to determine whether the user qualifies for a surplus line insurance policy. As explained with reference to FIG. 2, the policy issuance architecture 104 leverages third-party services, such as an address normalization service 106 and a hazard assessment service 112, to determine whether there are potential hazards they may affect the insurability of a particular property. Furthermore, the policy issuance architecture 104 brings together multiple state mandated rules and insurance underwriter rules to ensure that the determination and issuance of a surplus line insurance policy complies with the relevant laws and regulations. These features present a technical improvement over prior practices because prior practices often involved the consultation of multiple parties, non-trivial time delays (e.g., in verifying whether a standard insurance policy can be issued), the potential for human error (e.g., in review a document or determining the potential hazards for a particular property), unclear or misplaced documentation, and other such impediments to the issuance of a surplus line insurance policy. By obviating these deficiencies, the disclosed policy issuance architecture 104 improves the manner in which a surplus line insurance policy may be issued and addresses the inaccuracies that were inherently present in prior practice.

Modules, Components, and Logic

Certain embodiments are described herein as including logic or a number of components, modules, or mechanisms. Modules may constitute either software modules (e.g., code embodied on a machine-readable medium or machine-readable storage device) or hardware modules. A “hardware module” is a tangible unit capable of performing certain operations and may be configured or arranged in a certain physical manner. In various example embodiments, one or more computer systems (e.g., a standalone computer system, a client computer system, or a server computer system) or one or more hardware modules of a computer system (e.g., a processor or a group of processors) may be configured by software (e.g., an application or application portion) as a hardware module that operates to perform certain operations as described herein.

In some embodiments, a hardware module may be implemented mechanically, electronically, or any suitable combination thereof. For example, a hardware module may include dedicated circuitry or logic that is permanently configured to perform certain operations. For example, a hardware module may be a special-purpose processor, such as a FPGA or an ASIC. A hardware module may also include programmable logic or circuitry that is temporarily configured by software to perform certain operations. For example, a hardware module may include software executed by a general-purpose processor or other programmable processor. Once configured by such software, hardware modules become specific machines (or specific components of a machine) uniquely tailored to perform the configured functions and are no longer general-purpose processors. It will be appreciated that the decision to implement a hardware module mechanically, in dedicated and permanently configured circuitry, or in temporarily configured circuitry (e.g., configured by software) may be driven by cost and time considerations.

Accordingly, the phrase “hardware module” should be understood to encompass a tangible entity, be that an entity that is physically constructed, permanently configured (e.g., hardwired), or temporarily configured (e.g., programmed) to operate in a certain manner or to perform certain operations described herein. As used herein, “hardware-implemented module” refers to a hardware module. Considering embodiments in which hardware modules are temporarily configured (e.g., programmed), each of the hardware modules need not be configured or instantiated at any one instance in time. For example, where a hardware module comprises a general-purpose processor configured by software to become a special-purpose processor, the general-purpose processor may be configured as respectively different special-purpose processors (e.g., comprising different hardware modules) at different times. Software accordingly configures a particular processor or processors, for example, to constitute a particular hardware module at one instance of time and to constitute a different hardware module at a different instance of time.

Hardware modules can provide information to, and receive information from, other hardware modules. Accordingly, the described hardware modules may be regarded as being communicatively coupled. Where multiple hardware modules exist contemporaneously, communications may be achieved through signal transmission (e.g., over appropriate circuits and buses) between or among two or more of the hardware modules. In embodiments in which multiple hardware modules are configured or instantiated at different times, communications between such hardware modules may be achieved, for example, through the storage and retrieval of information in memory structures to which the multiple hardware modules have access. For example, one hardware module may perform an operation and store the output of that operation in a memory device to which it is communicatively coupled. A further hardware module may then, at a later time, access the memory device to retrieve and process the stored output. Hardware modules may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions described herein. As used herein. “processor-implemented module” refers to a hardware module implemented using one or more processors.

Similarly, the methods described herein may be at least partially processor-implemented, with a particular processor or processors being an example of hardware. For example, at least some of the operations of a method may be performed by one or more processors or processor-implemented modules. Moreover, the one or more processors may also operate to support performance of the relevant operations in a “cloud computing” environment or as a “software as a service” (SaaS). For example, at least some of the operations may be performed by a group of computers (as examples of machines including processors), with these operations being accessible via a network (e.g., the Internet) and via one or more appropriate interfaces (e.g., an API).

The performance of certain of the operations may be distributed among the processors, not only residing within a single machine, but deployed across a number of machines. In some example embodiments, the processors or processor-implemented modules may be located in a single geographic location (e.g., within a home environment, an office environment, or a server farm). In other example embodiments, the processors or processor-implemented modules may be distributed across a number of geographic locations.

Machine and Software Architecture

The modules, methods, applications and so forth described in conjunction with FIGS. 1-4D are implemented in some embodiments in the context of a machine and an associated software architecture. The sections below describe a representative architecture that is suitable for use with the disclosed embodiments.

Software architectures are used in conjunction with hardware architectures to create devices and machines tailored to particular purposes. For example, a particular hardware architecture coupled with a particular software architecture will create a mobile device, such as a mobile phone, tablet device, or so forth. A slightly different hardware and software architecture may yield a smart device for use in the “internet of things” while yet another combination produces a server computer for use within a cloud computing architecture. Not all combinations of such software and hardware architectures are presented here as those of skill in the art can readily understand how to implement the inventive subject matter in different contexts from the disclosure contained herein.

Example Machine Architecture and Machine-Readable Medium

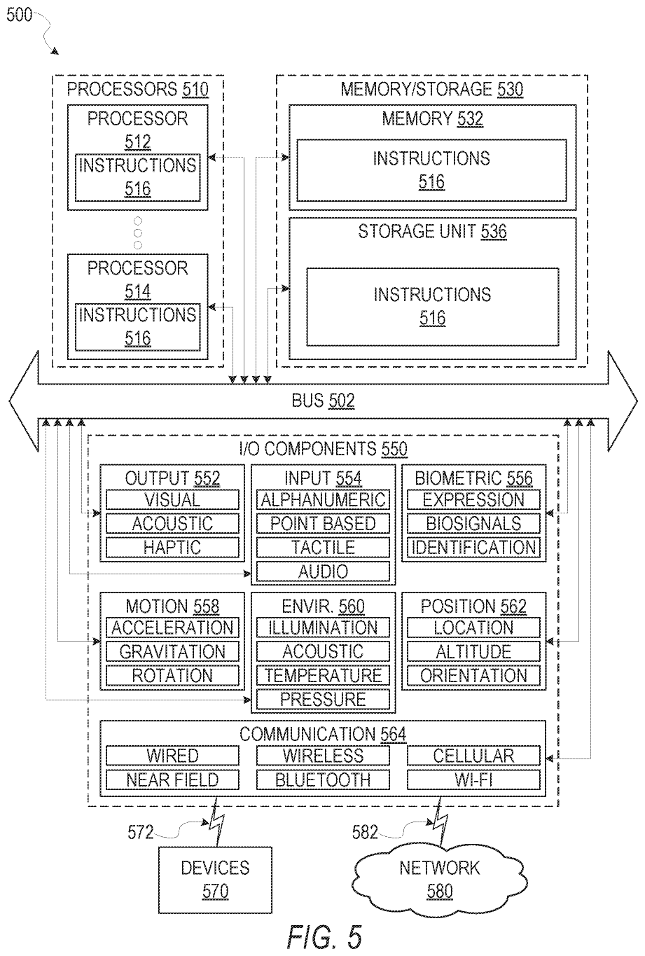

FIG. 5 is a block diagram illustrating components of a machine 500, according to some example embodiments, able to read instructions from a machine-readable medium (e.g., a machine-readable storage medium or machine-readable storage device) and perform any one or more of the methodologies discussed herein. Specifically, FIG. 5 shows a diagrammatic representation of the machine 500 in the example form of a computer system, within which instructions 516 (e.g., software, a program, an application, an applet, an app, or other executable code) for causing the machine 500 to perform any one or more of the methodologies discussed herein may be executed. For example, the instructions 516 may cause the machine 500 to execute the flow diagrams of FIGS. 4A-4D. Additionally, or alternatively, the instructions 516 may implement one or more of the components of FIGS. 1-2.

The instructions 516 transform the general, non-programmed machine 500 into a particular machine 500 programmed to carry out the described and illustrated functions in the manner described. In alternative embodiments, the machine 500 operates as a standalone device or may be coupled (e.g., networked) to other machines. In a networked deployment, the machine 500 may operate in the capacity of a server machine or a client machine in a server-client network environment, or as a peer machine in a peer-to-peer (or distributed) network environment. The machine 500 may comprise, but not be limited to, a server computer, a client computer, a personal computer (PC), a tablet computer, a laptop computer, a netbook, a PDA, or any machine capable of executing the instructions 516, sequentially or otherwise, that specify actions to be taken by machine 500. Further, while only a single machine 500 is illustrated, the term “machine” shall also be taken to include a collection of machines 500 that individually or jointly execute the instructions 516 to perform any one or more of the methodologies discussed herein.

The machine 500 may include processors 510, memory/storage 530, and I/O components 550, which may be configured to communicate with each other such as via a bus 502. In an example embodiment, the processors 510 (e.g., a Central Processing Unit (CPU), a Reduced Instruction Set Computing (RISC) processor, a Complex Instruction Set Computing (CISC) processor, a Graphics Processing Unit (GPU), a Digital Signal Processor (DSP), an ASIC, a Radio-Frequency Integrated Circuit (RFIC), another processor, or any suitable combination thereof) may include, for example, processor 512 and processor 514 that may execute the instructions 516. The term “processor” is intended to include multi-core processor that may comprise two or more independent processors (sometimes referred to as “cores”) that may execute instructions 516 contemporaneously. Although FIG. 5 shows multiple processors 510, the machine 500 may include a single processor with a single core, a single processor with multiple cores (e.g., a multi-core process), multiple processors with a single core, multiple processors with multiples cores, or any combination thereof.

The memory/storage 530 may include a memory 532, such as a main memory, or other memory storage, and a storage unit 536, both accessible to the processors 510 such as via the bus 502. The storage unit 536 and memory 532 store the instructions 516 embodying any one or more of the methodologies or functions described herein. The instructions 516 may also reside, completely or partially, within the memory 532, within the storage unit 536, within at least one of the processors 510 (e.g., within the processor's cache memory), or any suitable combination thereof, during execution thereof by the machine 500. Accordingly, the memory 532, the storage unit 536, and the memory of processors 510 are examples of machine-readable media.

As used herein, “machine-readable medium” includes a machine-readable storage device able to store instructions 516 and data temporarily or permanently and may include, but is not limited to, random-access memory (RAM), read-only memory (ROM), buffer memory, flash memory, optical media, magnetic media, cache memory, other types of storage (e.g., Erasable Programmable Read-Only Memory (EEPROM)) and/or any suitable combination thereof. The term “machine-readable medium” should be taken to include a single medium or multiple media (e.g., a centralized or distributed database, or associated caches and servers) able to store instructions 516. The term “machine-readable medium” shall also be taken to include any medium, or combination of multiple media, that is capable of storing instructions (e.g., instructions 516) for execution by a machine (e.g., machine 500), such that the instructions, when executed by one or more processors of the machine 500 (e.g., processors 510), cause the machine 500 to perform any one or more of the methodologies described herein. Accordingly, a “machine-readable medium” refers to a single storage apparatus or device, as well as “cloud-based” storage systems or storage networks that include multiple storage apparatus or devices. The term “machine-readable medium” excludes signals per se.

The input/output (I/O) components 550 may include a wide variety of components to receive input, provide output, produce output, transmit information, exchange information, capture measurements, and so on. The specific/O components 550 that are included in a particular machine will depend on the type of machine. For example, portable machines such as mobile phones will likely include a touch input device or other such input mechanisms, while a headless server machine will likely not include such a touch input device. It will be appreciated that the I/O components 550 may include many other components that are not shown in FIG. 5. The I/O components 550 are grouped according to functionality merely for simplifying the following discussion and the grouping is in no way limiting. In various example embodiments, the I/O components 550 may include output components 552 and input components 554. The output components 552 may include visual components (e.g., a display such as a plasma display panel (PDP), a light emitting diode (LED) display, a liquid crystal display (LCD), a projector, or a cathode ray tube (CRT)), acoustic components (e.g., speakers), haptic components (e.g., a vibratory motor, resistance mechanisms), other signal generators, and so forth. The input components 554 may include alphanumeric input components (e.g., a keyboard, a touch screen configured to receive alphanumeric input, a photo-optical keyboard, or other alphanumeric input components), point based input components (e.g., a mouse, a touchpad, a trackball, a joystick, a motion sensor, or other pointing instrument), tactile input components (e.g., a physical button, a touch screen that provides location and/or force of touches or touch gestures, or other tactile input components), audio input components (e.g., a microphone), and the like.

In further example embodiments, the I/O components 550 may include biometric components 556, motion components 558, environmental components 560, or position components 562 among a wide array of other components. For example, the biometric components 556 may include components to detect expressions (e.g., hand expressions, facial expressions, vocal expressions, body gestures, or eye tracking), measure biosignals (e.g., blood pressure, heart rate, body temperature, perspiration, or brain waves), identify a person (e.g., voice identification, retinal identification, facial identification, fingerprint identification, or electroencephalogram based identification), and the like. The motion components 558 may include acceleration sensor components (e.g., accelerometer), gravitation sensor components, rotation sensor components (e.g., gyroscope), and so forth. The environmental components 560 may include, for example, illumination sensor components (e.g., photometer), temperature sensor components (e.g., one or more thermometer that detect ambient temperature), humidity sensor components, pressure sensor components (e.g., barometer), acoustic sensor components (e.g., one or more microphones that detect background noise), proximity sensor components (e.g., infrared sensors that detect nearby objects), gas sensors (e.g., gas detection sensors to detection concentrations of hazardous gases for safety or to measure pollutants in the atmosphere), or other components that may provide indications, measurements, or signals corresponding to a surrounding physical environment. The position components 562 may include location sensor components (e.g., a GPS receiver component), altitude sensor components (e.g., altimeters or barometers that detect air pressure from which altitude may be derived), orientation sensor components (e.g., magnetometers), and the like.

Communication may be implemented using a wide variety of technologies. The I/O components 550 may include communication components 564 operable to couple the machine 500 to a network 580 or devices 570 via coupling 582 and coupling 572, respectively. For example, the communication components 564 may include a network interface component or other suitable device to interface with the network 580. In further examples, communication components 564 may include wired communication components, wireless communication components, cellular communication components. Near Field Communication (NFC) components, Bluetooth® components (e.g., Bluetooth® Low Energy), Wi-Fi® components, and other communication components to provide communication via other modalities. The devices 570 may be another machine or any of a wide variety of peripheral devices (e.g., a peripheral device coupled via a USB).

Moreover, the communication components 564 may detect identifiers or include components operable to detect identifiers. For example, the communication components 564 may include Radio Frequency Identification (RFID) tag reader components. NFC smart tag detection components, optical reader components (e.g., an optical sensor to detect one-dimensional bar codes such as Universal Product Code (UPC) bar code, multi-dimensional bar codes such as Quick Response (QR) code, Aztec code. Data Matrix. Dataglyph, MaxiCode, PDF416, Ultra Code, UCC RSS-2D bar code, and other optical codes), or acoustic detection components (e.g., microphones to identify tagged audio signals). In addition, a variety of information may be derived via the communication components 564, such as location via Internet Protocol (IP) geo-location, location via Wi-Fi® signal triangulation, location via detecting a NFC beacon signal that may indicate a particular location, and so forth.

Transmission Medium

In various example embodiments, one or more portions of the network 580 may be an ad hoc network, an intranet, an extranet, a VPN, a LAN, a WLAN, a WAN, a WWAN, a MAN, the Internet, a portion of the Internet, a portion of the PSTN, a plain old telephone service (POTS) network, a cellular telephone network, a wireless network, a Wi-Fi® network, another type of network, or a combination of two or more such networks. For example, the network 580 or a portion of the network 580 may include a wireless or cellular network and the coupling 582 may be a Code Division Multiple Access (CDMA) connection, a Global System for Mobile communications (GSM) connection, or other type of cellular or wireless coupling. In this example, the coupling 582 may implement any of a variety of types of data transfer technology, such as Single Carrier Radio Transmission Technology (1×RTT). Evolution-Data Optimized (EVDO) technology, General Packet Radio Service (GPRS) technology. Enhanced Data rates for GSM Evolution (EDGE) technology, third Generation Partnership Project (3GPP) including 3G, fourth generation wireless (4G) networks, Universal Mobile Telecommunications System (UMTS), High Speed Packet Access (HSPA), Worldwide Interoperability for Microwave Access (WiMAX), Long Term Evolution (LTE) standard, others defined by various standard setting organizations, other long range protocols, or other data transfer technology.

The instructions 516 may be transmitted or received over the network 580 using a transmission medium via a network interface device (e.g., a network interface component included in the communication components 564) and utilizing any one of a number of well-known transfer protocols (e.g., hypertext transfer protocol (HTTP)). Similarly, the instructions 516 may be transmitted or received using a transmission medium via the coupling 572 (e.g., a peer-to-peer coupling) to devices 570. The term “transmission medium” shall be taken to include any intangible medium that is capable of storing, encoding, or carrying instructions 516 for execution by the machine 500, and includes digital or analog communications signals or other intangible medium to facilitate communication of such software.

Language

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Although an overview of the inventive subject matter has been described with reference to specific example embodiments, various modifications and changes may be made to these embodiments without departing from the broader scope of embodiments of the present disclosure. Such embodiments of the inventive subject matter may be referred to herein, individually or collectively, by the term “invention” merely for convenience and without intending to voluntarily limit the scope of this application to any single disclosure or inventive concept if more than one is, in fact, disclosed.

The embodiments illustrated herein are described in sufficient detail to enable those skilled in the art to practice the teachings disclosed. Other embodiments may be used and derived therefrom, such that structural and logical substitutions and changes may be made without departing from the scope of this disclosure. The Detailed Description, therefore, is not to be taken in a limiting sense, and the scope of various embodiments is defined only by the appended claims, along with the full range of equivalents to which such claims are entitled.

As used herein, the term “or” may be construed in either an inclusive or exclusive sense. Moreover, plural instances may be provided for resources, operations, or structures described herein as a single instance. Additionally, boundaries between various resources, operations, modules, engines, and data stores are somewhat arbitrary, and particular operations are illustrated in a context of specific illustrative configurations. Other allocations of functionality are envisioned and may fall within a scope of various embodiments of the present disclosure. In general, structures and functionality presented as separate resources in the example configurations may be implemented as a combined structure or resource. Similarly, structures and functionality presented as a single resource may be implemented as separate resources. These and other variations, modifications, additions, and improvements fall within a scope of embodiments of the present disclosure as represented by the appended claims. The specification and drawings are, accordingly, to be regarded in an illustrative rather than a restrictive sense.

We claim:

1. A system for automatically determining and issuing a surplus line insurance policy, the system comprising:
a machine-readable medium storing computer-executable instructions; and
at least one hardware processor communicatively coupled to the machine-readable medium that, when the computer-executable instructions are executed, configures the system to:
receive address information for a property to be insured;
determine a hazard assessment value for the property to be insured based on the received address information, where the hazard assessment value indicates potential one or more hazards to the property to be insured;
select one or more policy determination rules to determine whether to issue a standard insurance policy for the property to be insured based on the received address information and the determined hazard assessment value;
in response to a determination that a standard insurance policy cannot be issued for the property to be insured, iteratively evaluate the selected one or more policy determination rules until a determination is reached as to whether to issue a surplus line insurance policy for the property to be insured;
based on a determination to issue a surplus line insurance policy for the property to be insured, generate a plurality of electronic documents associated with the surplus line insurance policy; and
cause a display of the generated plurality of electronic documents.

2. The system of claim 1, wherein the address information for the property to be insured is normalized according to an address normalization service in communication with the system

3. The system of claim 1, wherein the system further comprises a hazard database for storing a plurality of hazard assessment values, wherein each hazard assessment value is associated with a particular property to be insured.

4. The system of claim 1, wherein the hazard assessment value for the property to be insured is determined by a hazard assessment service in communication with the system.

5. The system of claim 1, wherein the determination as to whether to issue the surplus line insurance policy is based on a number of declinations received in response to the evaluation of the one or more policy determination rules.

6. The system of claim 1, wherein:
the one or more policy determination rules comprises a plurality of policy determination rules; and
selected ones of the plurality of policy determination rules are associated with different insurance underwriters.

7. The system of claim 1, wherein the system is further configured to cause a presentation of a message indicating whether a surplus line insurance policy can be issued for the property to be insured.

8. A method for automatically determining and issuing a surplus line insurance policy, the method comprising:
receiving address information for a property to be insured;
determining a hazard assessment value for the property to be insured based on the received address information, where the hazard assessment value indicates potential one or more hazards to the property to be insured;
selecting one or more policy determination rules to determine whether to issue a standard insurance policy for the property to be insured based on the received address information and the determined hazard assessment value;
in response to a determination that a standard insurance policy cannot be issued for the property to be insured, iteratively evaluating the selected one or more policy determination rules until a determination is reached as to whether to issue a surplus line insurance policy for the property to be insured;
based on a determination to issue a surplus line insurance policy for the property to be insured, generating a plurality of electronic documents associated with the surplus line insurance policy; and
causing a display of the generated plurality of electronic documents.

9. The method of claim 8, wherein the address information for the property to be insured is normalized according to an address normalization service accessed using an application programming interface

10. The method of claim 8, further comprising storing a plurality of hazard assessment values in hazard database, wherein each hazard assessment value is associated with a particular property to be insured.

11. The method of claim 8, wherein the hazard assessment value for the property to be insured is determined by a hazard assessment service accessed using an application programming interface.

12. The method of claim 8, wherein the determination as to whether to issue the surplus line insurance policy is based on a number of declinations received in response to the evaluation of the one or more policy determination rules.

13. The method of claim 8, wherein:
the one or more policy determination rules comprises a plurality of policy determination rules; and
selected ones of the plurality of policy determination rules are associated with different insurance underwriters.

14. The method of claim 8, further comprising:
causing a presentation of a message indicating whether a surplus line insurance policy can be issued for the property to be insured.

15. A machine-readable media for automatically having computer-executable instructions stored thereon that, when executed by one or more processors, cause a system to perform a plurality of operations comprising:
receiving address information for a property to be insured;
determining a hazard assessment value for the property to be insured based on the received address information, where the hazard assessment value indicates potential one or more hazards to the property to be insured;
selecting one or more policy determination rules to determine whether to issue a standard insurance policy for the property to be insured based on the received address information and the determined hazard assessment value;
in response to a determination that a standard insurance policy cannot be issued for the property to be insured, iteratively evaluating the selected one or more policy determination rules until a determination is reached as to whether to issue a surplus line insurance policy for the property to be insured;
based on a determination to issue a surplus line insurance policy for the property to be insured, generating a plurality of electronic documents associated with the surplus line insurance policy; and
causing a display of the generated plurality of electronic documents.

16. The machine-readable media of claim 15, wherein the address information for the property to be insured is normalized according to an address normalization service accessed using an application programming interface

17. The machine-readable media of claim 15, wherein the plurality of operations further comprises storing a plurality of hazard assessment values in hazard database, wherein each hazard assessment value is associated with a particular property to be insured.

18. The machine-readable media of claim 15, wherein the hazard assessment value for the property to be insured is determined by a hazard assessment service accessed using an application programming interface.

19. The machine-readable media of claim 15, wherein the determination as to whether to issue the surplus line insurance policy is based on a number of declinations received in response to the evaluation of the one or more policy determination rules.

20. The machine-readable media of claim 15, wherein the plurality of operations further comprises
causing a presentation of a message indicating whether a surplus line insurance policy can be issued for the property to be insured.
